(19) United States
(12) Patent Application Publication
(10) Pub. No.: US 2018/0075760 A1
(43) Pub. Date: Mar. 15, 2018

(54) SOLAR RECHARGEABLE UNMANNED VEHICLE SYSTEMS AND METHODS TO MONITOR A GEOGRAPHIC AREA

(71) Applicant: Wal-Mart Stores, Inc., Bentonville, AR (US)

(72) Inventors: John P. Thompson, Bentonville, AR (US); David C. Winkle, Bella Vista, AR (US); Michael D. Atchley, Springdale, AR (US); Donald R. High, Noel, MO (US); Todd D. Mattingly, Bentonville, AR (US); Brian G. McHale, Chadderton Oldham (GB); John J. O'Brien, Farmington, AR (US); John F. Simon, Pembroke Pines, FL (US); Robert L. Cantrell, Herndon, VA (US); Nathan G. Jones, Bentonville, AR (US); Robert C. Taylor, Rogers, AR (US)

(21) Appl. No.: 15/696,984

(22) Filed: Sep. 6, 2017

Related U.S. Application Data
(60) Provisional application No. 62/385,355, filed on Sep. 9, 2016.

(51) Int. Cl. G08G 5/00; B64C 39/02; G05D 1/00; G05B 19/042; G05D 1/10; H02J 50/20

(52) U.S. Cl. CPC G08G 5/0082; B64C 39/024; G05D 1/0088; B64C 2201/12; G05D 1/10; H02J 50/20; G05B 19/042

(57) ABSTRACT

Some embodiments provide an aerial monitoring system to monitor a geographic area, comprising: a unmanned aerial vehicle (UAV) comprising: a plurality of lift motors to drive a propeller; a substructural support supporting the lift motors and propellers; a UAV control circuit configured to control the operation of the lift motors; a rechargeable electrical power source that supplies electrical power to the UAV control circuit and the plurality of lift motors; a recharge control circuit; and a modifiable support system cooperated with the substructural support and supporting a set of photovoltaic cells electrically coupled with the rechargeable power source and configured to supply electrical power to the rechargeable power source, wherein the recharge control circuit is configured to control a modification of the modifiable support system to cause a physical modification of at least an orientation of the modifiable support system relative to the substructural support.

### CROSS-REFERENCE TO RELATED APPLICATION

This application claims the benefit of U.S. Provisional Application No. 62/385,355, filed Sep. 9, 2016, which is incorporated herein by reference in its entirety.

### TECHNICAL FIELD

This invention relates generally to systems to monitor geographic areas.

### BACKGROUND

Geographic areas can have numerous different uses. Often, activities and/or conditions regarding the areas may be determined. Obtaining the information can be time consuming and costly.

### BRIEF DESCRIPTION OF THE DRAWINGS

Disclosed herein are embodiments of systems, apparatuses and methods pertaining monitoring geographic areas. This description includes drawings, wherein:

FIG. 1 illustrates a simplified block diagram, cross-sectional view of an exemplary unmanned aerial vehicle (UAV), in accordance with some embodiments.

FIG. 2 illustrates a simplified block diagram, overhead view of an exemplary UAV, in accordance with some embodiments, with a modifiable support system in a retracted state.

FIGS. 3A-3D illustrate simplified block diagram, overhead views of various exemplary UAVs, in accordance with some embodiments, with modifiable support systems in extended states.

FIG. 4A illustrates a simplified block diagram of an exemplary UAV with an exemplary circular or tubular modifiable support system, in accordance with some embodiments.

FIGS. 4B-4C illustrate simplified block diagram, overhead views of the exemplary UAV of FIG. 4A with the circular modifiable support system in a tubular orientation and a flattened orientation, respectively.

FIG. 4D illustrates a simplified block diagram, side view of the exemplary UAV of FIG. 4A with the modifiable support system in the flattened orientation, in accordance with some embodiments.

FIG. 4E illustrates a simplified block diagram, side view of an exemplary UAV similar to that of FIG. 4A with the modifiable support system rotated relative to a substructural support.

FIG. 5 illustrates a simplified block diagram of an exemplary task and/or monitoring system, in accordance with some embodiments.

FIG. 6 illustrates an exemplary system for use in implementing methods, techniques, devices, apparatuses, systems, servers, sources and providing monitoring, in accordance with some embodiments.

FIG. 7 shows a simplified flow diagram of an exemplary process of monitoring a geographic area and/or implementing a task, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

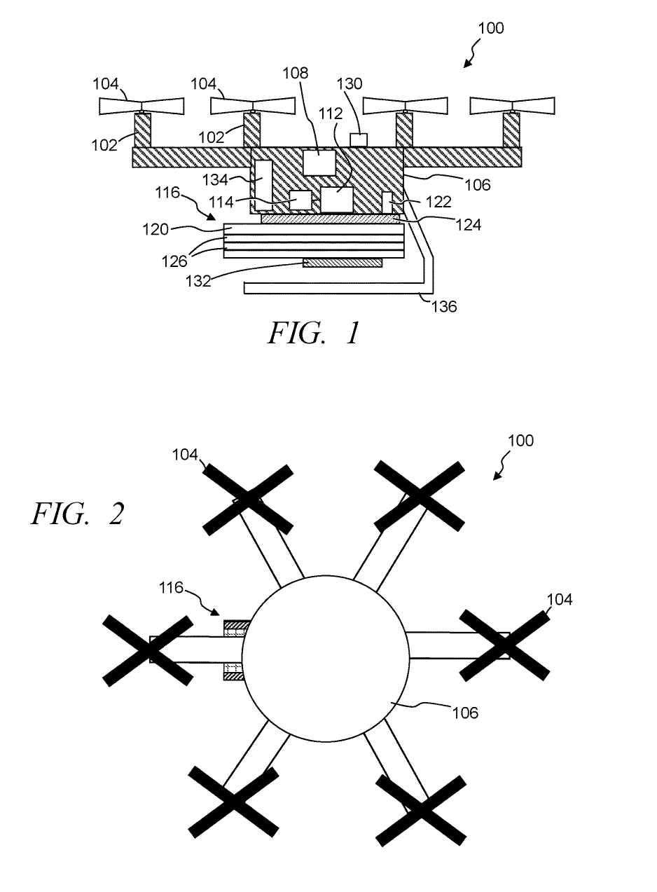

Generally speaking, pursuant to various embodiments, systems, apparatuses and methods are provided to enable aerial monitoring of one or more geographic areas. Some embodiments include one or more unmanned vehicles (e.g., unmanned ground vehicles (UGV) and/or unmanned aerial vehicles (UAV), which may be similar or different than those illustrated in FIGS. 1-4E). For simplicity, the below describes the vehicles as UAVs, however, many of features can equally be applied to UGVs. In some embodiments, the vehicles include a propulsion system. For example, a propulsion system of the UAVs can have a plurality of lift motors that are each configured to drive at least one propeller to induce at least a lifting force that allows the respective UAV to fly and hover over one or more zones of the geographic area. The UAVs each include a substructural support, frame, body or the like that supports the lift motors and propellers. A UAV control circuit is also included in each of the UAVs and couples with the lift motors and is configured to control rotations per minute of the propellers in controlling lift and/or movement of the respective UAV. In some embodiments, the UAVs include a rechargeable electrical power source coupled with the UAV control circuit and the plurality of lift motors supplying electrical power to the UAV control circuit and the plurality of lift motors and one or more modifiable support systems cooperated with the substructural support. The modifiable support system supports a set of photovoltaic cells electrically coupled with the rechargeable power source and configured to supplying electrical power to the rechargeable power source. Some embodiments further include a recharge control circuit that controls a modification of the modifiable support system to cause a physical modification of at least an orientation of the modifiable support system relative to the substructural support. Accordingly, the UAV can recharge the rechargeable power source while the UAV is in flight.

FIG. 1 illustrates a simplified block diagram, cross-sectional view of an exemplary unmanned aerial vehicle (UAV) 100, in accordance with some embodiments. The UAV has a plurality of lift motors 102 that each couple with at least one propeller 104 to drive the propellers to induce at least a lifting force to enable the UAV to fly and hover over one or more zones of one or more geographic areas. The number and/or power level of the motors can vary depending on intended implementation and/or use of the UAV. The UAV further includes a substructural support 106, body, frame, housing and/or other support structure to support at least the plurality of lift motors, propellers and other components of the UAV. In some embodiments, the substructural support includes a housing that encloses some or all of a series of components. In other embodiments, the substructural support comprises a simple framing that supports the components for operation. Further, the substructural support may be configured to enable components to be readily added or removed. A UAV control circuit 108 is secured with the substructural support and couples with the lift motors and in part is configured to control the operation of the lift motors in controlling lift and movement of the UAV. In some instances, the control circuit controls the rotations per minute of the propellers to achieve the desired lift and/or propulsion for the UAV. The UVA further includes a rechargeable electrical power source 112 coupled with the UAV control circuit and the plurality of lift motors supplying electrical power to the UAV control circuit and the plurality of lift motors. The rechargeable power source can include one or more rechargeable batteries, capacitors, other such electrical power storage devices, or combination of two or more of such power sources.

In some embodiments, the UAV may include one or more modifiable support systems 116 that are secured and cooperated with the substructural support 106. The modifiable support system is configured to support one or more sets of photovoltaic cells, which can be substantially any relevant electrical device that convert the energy of light into electrical power in response to being exposed to light (e.g., photodiodes, multicrystalline cells, polycrystalline silicon cells, Amorphous silicon cells, other semiconductor cells, photoelectrochemical cells, etc.). The photovoltaic cells are electrically coupled with the rechargeable power source 112 and configured to supplying electrical power to be stored in the rechargeable power source. Some embodiments may include a recharge control circuit 114 that controls and/or directs a modification of the modifiable support system 116 to cause a physical modification of at least an orientation of the modifiable support system relative to the substructural support. In some applications, the recharge control circuit may be part of the UVA control circuit, while in other implementations the recharge control circuit is separate from and in communication with the UVA control circuit.

The modifiable support system 116 can be controlled to modify to orient some or all of the photovoltaic cells relative to the substructural support 106. In some instances, the modification is configured to expose some or additional photovoltaic cells to one or more light sources, while in other instances, the physical modification positions one or more of the photovoltaic cells in a desired orientation to enhance exposure to the one or more light sources. In some embodiments, the recharge control circuit 114 activates the modifiable support system to cause the modifiable support system to extend away from the substructural support 106 to expose the photovoltaic cells. Similarly, the recharge control circuit can control and/or activate the modifiable support system to cause the modifiable support system to retract the modifiable support system toward the substructural support.

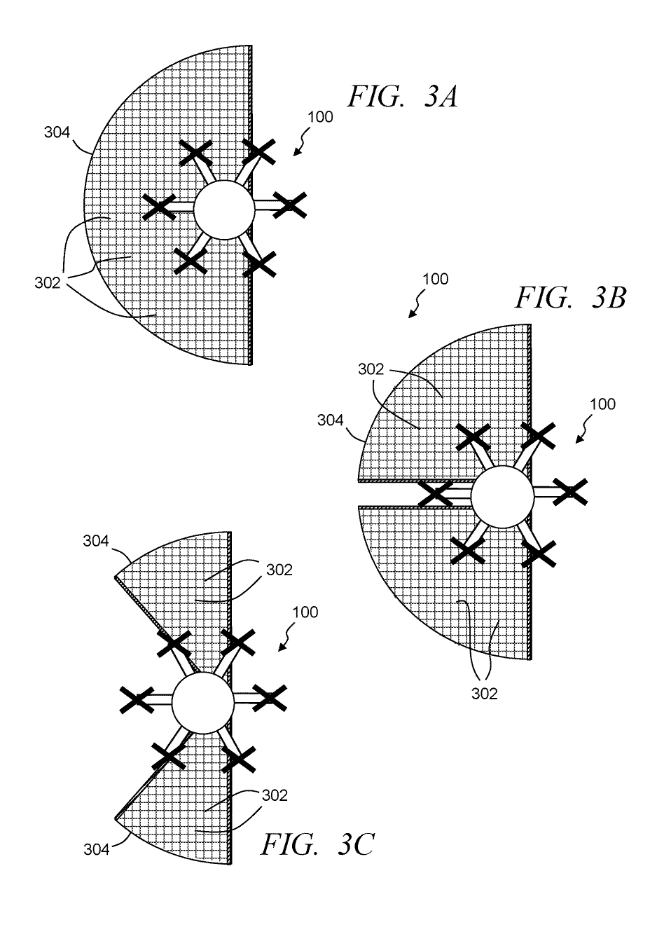

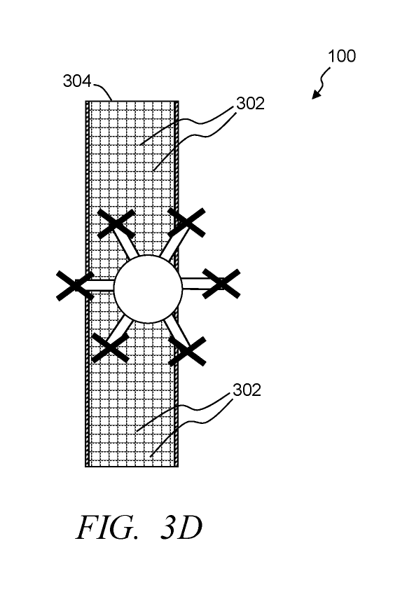

FIG. 2 illustrates a simplified block diagram, overhead view of an exemplary UAV 100, in accordance with some embodiments, with the modifiable support system 116 in a retracted, closed, collapsed and/or compressed state. FIGS. 3A-3D illustrate simplified block diagram, overhead views of various exemplary UAVs 100, in accordance with some embodiments, with modifiable support systems 116 in extended, open, and/or expanded states. Referring to FIGS. 1-3D, in the extended or exposed states at least some of the one or more sets of photovoltaic cells 302 are exposed. Similarly, in some embodiments, when the modifiable support system is in the retracted state some or all of the photovoltaic cells are protected from environmental conditions, while in other instances when in the retracted state some of the photovoltaic cells may be exposed. The modifiable support system may be controlled to be partially extended (e.g., based on weather and/or wind conditions), fully extended or fully retracted.

In some embodiments, the modifiable support system includes one or more support beams 120, framing and/or other such support structures that are at least temporarily secured with the UVA and support the one or more sets of photovoltaic cells. In some applications, one or more of the support beams 120 are coupled with one or more support system motors 122, actuators, pumps, valves and/or other such mechanisms or combination of two or more of such mechanisms to cause the one or more support beams or other structure of the modifiable support system to move to expose the photovoltaic cells and/or expand one or more cell supports 304 or other backing that are configured to support the photovoltaic cells. Further, the cell supports 304 may, in some implementations, be formed from a flexible material, malleable material, foldable material, or the like (e.g., fabric, silk, rubber, silicon, plastic, nylon, polyurethane fabric, metal foil, etc.), while in other instances some or all of the cell supports 304 may be relatively rigid (e.g., formed from plastic, Styrofoam, metal, carbon fiber, other such relevant material), or a combination of flexible and rigid materials. In some embodiments, for example, some or all of the one or more cell supports can include a mesh structure and/or include one or more apertures. Some or all of the one or more sets of photovoltaic cells can be secured with the mesh structure. The mesh structure and/or the apertures enabling airflow through the mesh structure and/or apertures at least when the modifiable support system is extended away from the substructural support. One or more ribs or other such stiffening and/or supporting structure may be further be included. In some applications, the modifiable support system includes multiple panels or segments that can overlap when retraced, and spread out when extended.

Further, in some embodiments, the modifiable support system does not provide a lifting force to the UAV. Instead, the lifting force is provided through the lift motors 102 and propellers 104. For example, in some implementations having the cell support 304 formed from a flexible membrane, the extended modifiable support system may have a generally wing configuration but does not provide a lifting force. In other embodiments, however, some or all of the modifiable support systems may be formed to provide a lift force and/or may assist in maintaining flight. For example, at least a portion of the modifiable support system can be formed with a generally air-foil shape that when appropriately oriented can provide some lift force when the UAV is moving. Such configuration of the modifiable support system can enhance flight times and/or allow the UAV to glide.

In some embodiments, the modifiable support system 116 and/or portions of the modifiable support system (e.g., the extendible portions) are fixed to the substructural support 106 of the UAV 100, while in other implementations some or all of the modifiable support system can be temporarily and releasably coupled with the substructural support. Some embodiments include one or more mounting systems and/or release mechanisms 124. The release mechanism may be configured to disengage the modifiable support system from the UAV, such as through a retraction of one or more pins, activating and/or deactivating electromagnets, activating a piston to push the modifiable support system, activating one or more motors to move the modifiable support system to move from an engaged position, and/or other such methods. In some embodiments, the recharge control circuit 114 in modifying the modifiable support system activates the one or more release mechanisms to release the modifiable support system from the substructural support separating the UAV from the modifiable support system and enabling the UAV to fly without the modifiable support system. This can reduce the weight of the UAV, which can extend a flight time of the UAV. In some instances, the recharge control circuit identifies when the rechargeable power source 112 has been recharged to a threshold level, and can direct the release of the modifiable support system. The recharge control circuit may further notify the UAV control circuit to cause the UAV to be flown to a drop location, docking station or the like before the recharge control circuit activates the one or more release mechanisms 124. For example, the release mechanism may be activated by UVA control circuit or the recharge control circuit to disengage. In other implementations, the UAV may cooperate the modifiable support system with a docking station that activates (physically or through communication) the release mechanism, and/or other such activations.

The UAV control circuit and/or the recharge control circuit can further be configured to adjust an orientation of the photovoltaic cells and/or the modifiable support system 116 in attempts to improve the amount of electrical power generated by some or all of the photovoltaic cells. This adjustment may include causing a rotation, tilt, angular positioning and/or other such adjustments in attempt to, in part, increase the light exposure of the photovoltaic cells and/or align the photovoltaic cells with one or more light sources. Similar adjustments to orientation may be made, in some implementations, based on movement of the UAV, such as to reduce wind drag. Some embodiments include one or more sensors 130 to detect an orientation of one or more sources of light relative to a position of the UAV. The one or more sensors can supply sensor information to the UAV control circuit and/or the recharge control circuit. In some embodiments, the recharge control circuit is communicatively coupled with the one or more sensors and/or otherwise receives sensor information, and can cause a change in physical orientation of the modifiable support system 116 as a function of the determined orientation of the source of light relative to the UAV. The change in orientation can increase an exposure of the set of photovoltaic cells 302 to the source of light. Again, the change in orientation can be through tilting, rotation, angular positioning, further extending or retracting the support beams 120, inducing a deflection of one or more ribs and/or one or more of the cell supports 304, other such adjustments, or combination of two or more of such adjustments. One or more support system motors 122, electromagnets, magnets, spindles, wires, gearing and/or other methods can be used to induce the adjustments.

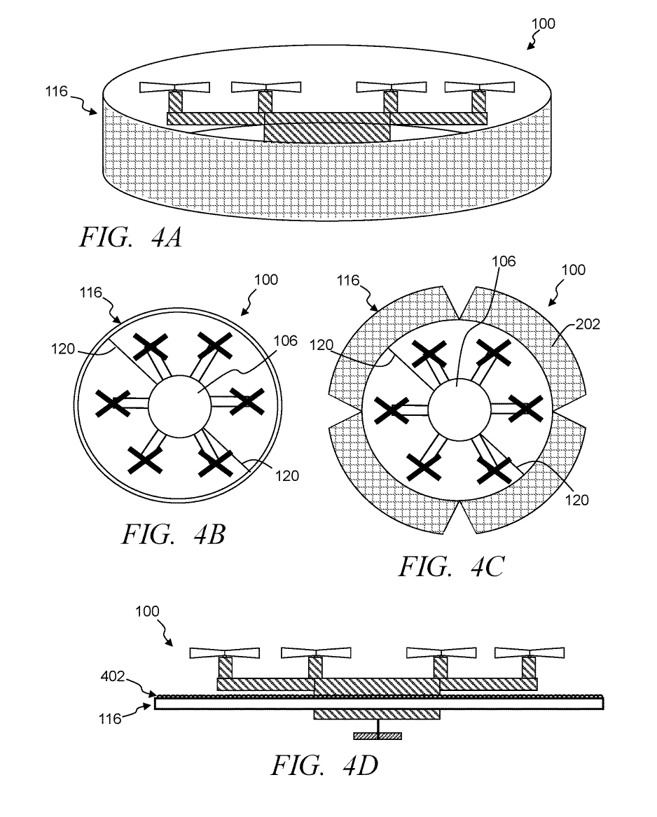

FIG. 4A illustrates a simplified block diagram of an exemplary UAV 100 with an exemplary circular or tubular modifiable support system 116, in accordance with some embodiments. The circular modifiable support system 116 includes one or more cell supports 304. FIGS. 4B-4C illustrate simplified block diagram, overhead views of the exemplary UAV 100 of FIG. 4A with the circular modifiable support system in a tubular orientation and a flattened orientation, respectively, relative to the substructural support 106, in accordance with some embodiments. FIG. 4D illustrates a simplified block diagram, side view of the exemplary UAV of FIG. 4A with the modifiable support system 116 in the flattened orientation, similar to that of FIG. 4C, in accordance with some embodiments. One or more support beams 120, cables and/or other such support framing can extend from the substructural support 106 of the UAV to support the modifiable support system. Further, the adjustment of the support beams 120, cables or other such mechanisms can enable the recharge control circuit and/or UAV control circuit to adjust the orientation of the one or more set of photovoltaic cells and/or the one or more cell supports 304. For example, the recharge control circuit can cause the modifiable support system to be adjusted from the tubular orientation to an angled orientation (e.g., angled at 40 degrees with a bottom circumference being greater than the top circumference), or to a flattened orientation.

In some embodiments, the adjustment can include rotation of the modifiable support system. FIG. 4E illustrates a simplified block diagram, side view of an exemplary UAV similar to that of FIG. 4A with the modifiable support system 116 rotated relative to the substructural support while in the tubular orientation, in accordance with some embodiments. The rotation can be in substantially any direction relative to the substructural support. In some applications, the UAV control circuit can direct the rotation to reduce drag on the UAV as it travels. Additionally or alternatively, the rotation may be implemented to enhance the alignment of one or more sets of photovoltaic cells relative to one or more light sources.

Some embodiments utilize one or more sensors 130 to detect one or more sources of light. The light sources can be direct sunlight, reflected light, light from electrically powered lights, and the like. For example, one or more sensors may be configured to detect one or more sources of sunlight and one of those sources may be a reflected source of sunlight, such as off a substructural support of water, off a building, etc. The recharge control circuit can evaluate sensor information and cause the change in physical orientation of the modifiable support system to increase the exposure of one or more of the set of photovoltaic cells to the reflected source of sunlight.

Further, some embodiments include one or more enhancement features that are configured to enhance the light directed at the photovoltaic cells. In some embodiments, for example, the modifiable support system 116 may include one or more set of lenses 402. The lenses can be positioned to direct light toward one or more of the photovoltaic cells. One or more set of lenses may be configured such that each lens is positioned relative to at least one of the photovoltaic cells of the set of photovoltaic cells and configured to increase a quantity of light directed on the respective at least one photovoltaic cell. In some applications, each lens may extend over multiple different photovoltaic cells. In other implementations, the set of lenses may comprise small or nano-lenses with each lens aligned with a single photovoltaic cell. For example, some embodiments may employ Fresnel lens and/or other lens configurations to direct light at the photovoltaic cells.

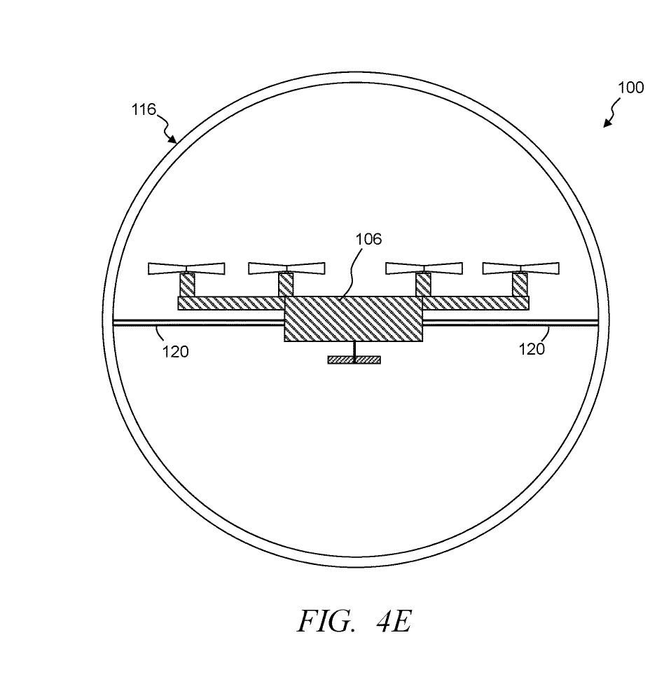

FIG. 5 illustrates a simplified block diagram of an exemplary task and/or monitoring system 500, in accordance with some embodiments. The monitoring system 500 can be implemented to monitor one or more geographic areas, such as but not limited to areas for traffic, areas for pedestrian safety, areas for security, crop conditions, soil conditions, and/or other such monitoring. Similarly, the system can additionally or alternatively direct the implementation of one or more tasks, such as but not limited to delivery of one or more items, capture images, capture video, position one or more sensors to provide information (e.g., soil moisture, temperature, humidity, rain fall, etc.), provide a wireless communication hub and/or network, take samples of plants, detect pests on plants, monitor traffic, perform deliveries of one or more items, transport items, other such tasks, or combination of two or more of such tasks. In some applications, the system enables the operation of an unmanned aerial system that utilizes multiple UAVs.

In some embodiments, the system 500 is an aerial monitoring system and/or ground monitoring system. Further, the system can provide and/or enables the operation of an unmanned aerial system that utilizes multiple unmanned vehicles. The system can include one or more central control systems 502, multiple unmanned vehicles 100 (unmanned ground vehicles (UGV) and/or unmanned aerial vehicles (UAV), which may be similar or different than those illustrated in FIGS. 1-4E). The UAVs may communicate with the central control system and/or with each other through one or more communication and/or computer networks 504, which can be configured to provide wireless and/or wired communication. The one or more networks can include local area networks (LAN), wide area networks (WAN), cellular communication, satellite communication, and/or other such communication networks and/or computer networks. The aerial system, in some applications, may include one or more docking stations 506 and/or tool stations. The docking station may be configured to receive one or more UAVs when not in service and/or provide recharging of one or more of the rechargeable power sources 112 of one or more UAVs 100. The docking and/or tool station may further maintain sensors, tools and/or other operations components that can be cooperated with one or more of the UAVs to be placed by a UAV and/or utilized through one or more UAVs to perform one or more tasks. In some applications, the docking and/or tool station may further enable the cooperation of one or more items with the UAVs to be delivered. For example, products may be cooperated with UAVs for delivery to customers.

Further, some embodiments may include one or more communication stations 508, which in part may enable communication between UAVs and/or one or more UAVs and the central control system. One or more sensors and/or sensor systems 512 may additionally be included. The sensors may be sensors placed by one or more UAVs (e.g., soil moisture sensors, temperature sensors, rain sensors, pest sensors, movement sensors, and/or other such sensors), or other sensors. Further, the sensors may provide information to the UAVs and/or the central control system to be used to control the flights of the UAVs and/or the monitoring of the one or more geographic areas (e.g., wind speed, weather forecasting, air traffic, and/or other such information). In some embodiments, the aerial and/or ground monitoring system 500 may include one or more RF generators 514 that are configured to generate RF signals that can be received by one or more UAVs to charge the rechargeable power source 112. In some embodiments, one or more UAVs 100 may further include a radio frequency (RF) charging system 134 cooperated with the substructural support and electronically coupled with the rechargeable power source 114. The RF charging system is configured to receive a wirelessly radiated and remotely generated RF electromagnetic field from one or more of the RF generators 514, and to generate electrical power based on the RF electromagnetic field to charge the rechargeable electrical power source 114. In some instances, for example, the RF recharging may be implemented through a system similar to that described in U.S. Pat. No. 6,114,834, or U.S. Pat. No. 8,307,922, which are incorporated herein by reference.

One or more UAVs 100 can be directed to perform one or more tasks. In some embodiments one or more UAV control systems and/or the central control system 502 can coordinate the operation of multiple UAVs. In other implementations, a user may program and/or communicate instructions to a single UAV to perform a task. The tasks can be substantially any task, such as but not limited to capture video, capture images, position one or more sensors to provide information (e.g., soil moisture, temperature, humidity, rain fall, etc.), provide a wireless communication hub and/or network, take samples of plants, detect pests on plants, monitor traffic, perform deliveries of one or more items, transport items, other such tasks, or combination of two or more of such tasks. In preforming the tasks, the UAVs may determine a route to follow and/or be directed to follow one or more routes. The routes may be determined in part based on potential exposure to light, and/or routes may be modified during flight in part due to exposure to light. In some embodiments a UAV control circuit 108 can be configured to modify a route of travel of the UAV while the UAV is in flight as a function of the orientation of the source of light relative to the UAV to increase the exposure of one or more sets of photovoltaic cells to the source of light. Similarly, a central control system may communication the route and/or modifications to a route based on an orientation of the source of light. The orientation may be determined by the UAV or sensor information from the UAV, another UAV or other sensors, or other information can be considered (e.g., historic data, almanac data, etc.) to identify the orientation of the light source (which may include reflected light, such as from a substructural support of water), and/or objects that can limit exposure to one or more light sources (e.g., buildings, bridges, trees, etc.). Using the orientation information the UAV control circuit and/or a central control system can direct one or more UAVs along an intended route, which may enhance exposure to light sources.

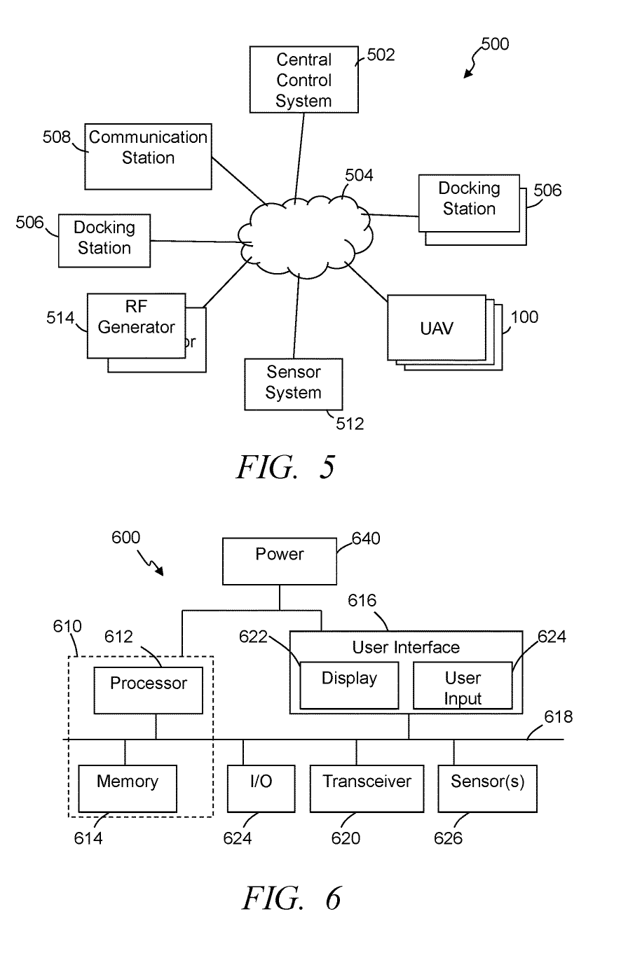

Further, the circuits, circuitry, systems, devices, processes, methods, techniques, functionality, services, servers, sources and the like described herein may be utilized, implemented and/or run on many different types of devices and/or systems. FIG. 6 illustrates an exemplary system 600 that may be used for implementing any of the components, circuits, circuitry, systems, functionality, apparatuses, processes, or devices of the UAVs 100 of FIGS. 1-5, the system 500 of FIG. 5, and/or other above or below mentioned systems or devices, or parts of such circuits, circuitry, functionality, systems, apparatuses, processes, or devices. For example, the system 600 may be used to implement some or all of UAVs 100, the UAV control circuits 108, the central control system 502, a docking stations 506, a communication station 508, a sensor system 512, an RF generator 514, and/or other such components, circuitry, functionality and/or devices. However, the use of the system 600 or any portion thereof is certainly not required.

By way of example, the system 600 may comprise a control circuit or processor module 612, memory 614, and one or more communication links, paths, buses or the like 618. Some embodiments may include one or more user interfaces 616, and/or one or more internal and/or external power sources or supplies 640. The control circuit 612 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 612 can be part of control circuitry and/or a control system 610, which may be implemented through one or more processors with access to one or more memory 614 that can store instructions, code and the like that is implemented by the control circuit and/or processors to implement intended functionality. For example, the control system 610 and/or control circuit 612 can implement the UAV control circuit 108, the recharge control circuit 114, or a combination of some or all of the UAV control circuit and the recharge control circuit. In some applications, the control circuit and/or memory may be distributed over a communications network (e.g., LAN, WAN, Internet) providing distributed and/or redundant processing and functionality. Again, the system 600 may be used to implement one or more of the above or below, or parts of, components, circuits, systems, processes and the like.

The user interface 616 can allow a user to interact with the system 600 and receive information through the system. In some instances, the user interface 616 includes a display 622 and/or one or more user inputs 624, such as buttons, touch screen, track ball, keyboard, mouse, etc., which can be part of or wired or wirelessly coupled with the system 600. Typically, the system 600 further includes one or more communication interfaces, ports, transceivers 620 and the like allowing the system 600 to communicate over a communication bus, a distributed computer and/or communication network 504 (e.g., a local area network (LAN), the Internet, wide area network (WAN), etc.), communication link 618, other networks or communication channels with other devices and/or other such communications or combination of two or more of such communication methods. Further the transceiver 620 can be configured for wired, wireless, optical, fiber optical cable, satellite, or other such communication configurations or combinations of two or more of such communications. Some embodiments include one or more input/output (I/O) ports 634 that allow one or more devices to couple with the system 600. The I/O ports can be substantially any relevant port or combinations of ports, such as but not limited to USB, Ethernet, or other such ports. The I/O interface 634 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 626 to provide information to the system and/or sensor information that is communicated to another component, such as the central control system, a UAV, etc. The sensors can include substantially any relevant sensor, such as distance measurement sensors (e.g., optical units, sound/ultrasound units, etc.), sonar sensor systems, inertia sensors, location sensors, wireless communication signal sensors, RF charge signal sensors, and/or other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 600 comprises an example of a control and/or processor-based system with the control circuit 612. Again, the control circuit 612 can be implemented through one or more processors, controllers, central processing units, logic, software and the like. Further, in some implementations the control circuit 612 may provide multiprocessor functionality.

The memory 614, which can be accessed by the control circuit 612, typically includes one or more processor readable and/or computer readable media accessed by at least the control circuit 612, and can include volatile and/or nonvolatile media, such as RAM, ROM, EEPROM, flash memory and/or other memory technology. Further, the memory 614 is shown as internal to the control system 610; however, the memory 614 can be internal, external or a combination of internal and external memory. Similarly, some or all of the memory 614 can be internal, external or a combination of internal and external memory of the control circuit 612. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 504. The memory 614 can store code, software, executables, scripts, data, content, lists, programming, programs, log or history data, user information, customer information, product information, and the like. While FIG. 6 illustrates the various components being coupled together via a bus, it is understood that the various components may actually be coupled to the control circuit and/or one or more other components directly.

The system 500 in part enables the powering of unmanned vehicles (e.g., unmanned aerial vehicles (UAV) and unmanned ground vehicles (UGV)). The vehicles include multiple photovoltaic cells and/or one or more solar panels that can recharge the rechargeable power source 112 of the vehicle while exposed to one or more light sources (e.g., while the sun is out). Some or all of the photovoltaic cells may be cooperated with modifiable and/or retractable support system to allow for smaller dimensions for some implementations (e.g., storage, fitting into certain locations, etc.). Further, in some applications the modifiable support system may include wings upon which one or more sets of photovoltaic cells are positioned. Consistent with the ability to physically modify the modifiable support system, in some applications the wings may be retractable or partially retractable. The one or more sets of photovoltaic cells are electrically coupled with one or more rechargeable electrical power storage sources that can be recharged by the photovoltaic cells and supply power to the unmanned vehicle to allow the unmanned vehicle to implement intended functionality, such as continuous monitoring of an area of crops. In some applications one or more power storage cells may be detachable (e.g., to be replaced when below a threshold). The system can include one or more sensors or detectors that can detect an orientation of one or more light sources relative to some or all of the photovoltaic cells. The recharge control circuit can cause an adjustment to an orientation of one or more of the modifiable support systems and/or the photovoltaic cells relative to the orientation of one or more light sources. In some applications, the UAV control circuit 108 of the unmanned vehicle may adjust a direction of travel and/or route based on an orientation of one or more light sources in attempts to enhance an orientation of the photovoltaic cells relative to the one or more light sources. The photovoltaic cells can provide power to enable longer operating and/or flight times, and/or provide power to implement one or more tools to perform one or more tasks. The unmanned vehicles may additionally or alternatively be configured to be remotely charged through remote RF charging.

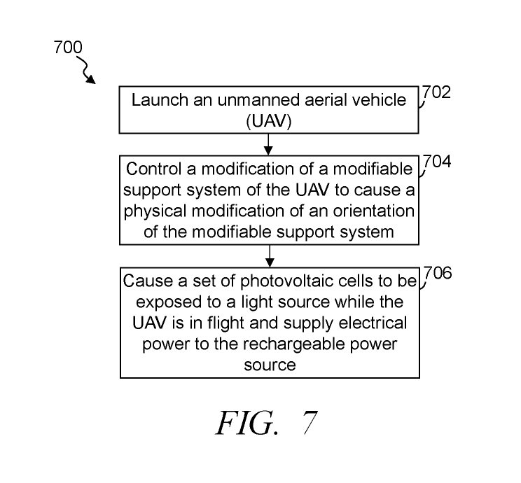

FIG. 7 shows a simplified flow diagram of an exemplary process 700 of monitoring a geographic area and/or implementing a task, in accordance with some embodiments. In step 702, one or more UAVs 100 may be launched. In step 704, a modification of one or more modifiable support systems is controlled to cause a physical modification of at least an orientation of one or more of the modifiable support systems 116 relative to the substructural support 106 of the UAV. In step 706, one or more sets of photovoltaic cells are caused to be exposed to a light source while the UAV is in flight and supplying electrical power to the rechargeable power source 112.

Some embodiments, in controlling the modification of the modifiable support system cause the modifiable support system 116 to extend away from the substructural support 106 to expose the photovoltaic cells. Alternatively, the control can cause the modifiable support system to retract toward the substructural support. In some instances, the retraction can reduce the exposed size of the modifiable support system and/or the wind drag that it may cause on the UAV. The extension away from the substructural support of the modifiable support system can, in some implementations, expose a mesh structure and/or structure with one or more apertures of the modifiable support system and upon which at least some of the one or more sets of photovoltaic cells are secured. The mesh structure, in part, enables airflow through the mesh structure at least when the modifiable support system is extended away from the substructural support. Further, the mesh structure may reduce the weight of the modifiable support system in some applications. Additionally or alternatively, some embodiments can activate a release mechanism that causes a release of the modifiable support system from the substructural support separating the UAV from the modifiable support system and enabling the UAV to fly without the modifiable support system.

The modifiable support system can be configured so that, in some embodiments, it does not provide a lifting force to the UAV. In other embodiments, the modifiable support system can be configured to provide some lift, while in some implementations, the modifiable support system allows the UAV to glide for extended distances. Further, some embodiments detect an orientation of a source of light relative to a position of the UAV, and cause a change in physical orientation of the modifiable support system as a function of the orientation of the source of light relative to the UAV. This change in orientation can be through a rotation, tilt, partial or further extension, partial retraction, and/or other such modifications. Typically, the change in orientation increases an exposure of one or more sets of photovoltaic cells to the source of light. In some instances, the detection of the orientation of the source of light can include detecting a reflected source of light. in changing the physical orientation, some embodiments can cause the change in physical orientation to increase the exposure of the one or more sets of photovoltaic cells to the reflected source of light. Some embodiments may additionally or alternatively modify a route of travel of the UAV while the UAV is in flight as a function of the orientation of the source of light relative to the UAV to increase the exposure of one or more sets of photovoltaic cells to the source of light.

Some embodiments further enhance the operation of the photovoltaic cells by in part exposing a set of lenses each positioned relative to at least one of the photovoltaic cells, which can cause an increase in a quantity of light directed on the respective at least one photovoltaic cell. As described above, the photovoltaic cells recharge the rechargeable power source 112. Some embodiments may additionally or alternatively wirelessly receive a radiated and remotely generated radio frequency (RF) electromagnetic field, and generate electrical power based on the RF electromagnetic field to charge the rechargeable electrical power source 112.

In some embodiments, systems and methods are provided to enable operation of UAVs to perform one or more tasks, such as monitoring a geographic area, obtaining sensor information placing sensors, delivering items, and/or other such tasks. Some embodiments provide an aerial monitoring system to monitor a geographic area, comprising: at least a first unmanned aerial vehicle (UAV) comprising: a plurality of lift motors each configured to drive at least one propeller to induce at least a lifting force to cause the first UAV to fly and hover over one or more zones of the geographic area; a substructural support supporting the plurality of lift motors and propellers; a UAV control circuit coupled with the lift motors and configured to control the operation of the lift motors in controlling lift and movement of the first UAV; a rechargeable electrical power source coupled with the UAV control circuit and the plurality of lift motors supplying electrical power to the UAV control circuit and the plurality of lift motors; a recharge control circuit; and a modifiable support system cooperated with the substructural support and supporting a set of photovoltaic cells electrically coupled with the rechargeable power source and configured to supply electrical power to the rechargeable power source, wherein the recharge control circuit is configured to control a modification of the modifiable support system to cause a physical modification of at least an orientation of the modifiable support system relative to the substructural support.

Some embodiments provide methods of monitoring a geographic area, comprising: launching at least a first unmanned aerial vehicle (UAV) comprising a plurality of lift motors and propellers to induce at least a lifting force to cause the first UAV to fly and hover over one or more zones of the geographic area, a substructural support, a UAV control circuit configured to control the lift motors, a rechargeable electrical power source configured to supply electrical power to the UAV control circuit and the plurality of lift motors, a recharge control circuit, and a modifiable support system cooperated with the substructural support and supporting a set of photovoltaic cells electrically coupled with the rechargeable power source; controlling a modification of the modifiable support system to cause a physical modification of at least an orientation of the modifiable support system relative to the substructural support; and causing the set of photovoltaic cells to be exposed to a light source while the first UAV is in flight and supply electrical power to the rechargeable power source.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. An aerial monitoring system to monitor a geographic area, comprising:
at least a first unmanned aerial vehicle (UAV) comprising:
a plurality of lift motors each configured to drive at least one propeller to induce at least a lifting force to cause the first UAV to fly and hover over one or more zones of the geographic area;
a substructural support supporting the plurality of lift motors and propellers;
a UAV control circuit coupled with the lift motors and configured to control the operation of the lift motors in controlling lift and movement of the first UAV;
a rechargeable electrical power source coupled with the UAV control circuit and the plurality of lift motors supplying electrical power to the UAV control circuit and the plurality of lift motors;
a recharge control circuit; and
a modifiable support system cooperated with the substructural support and supporting a set of photovoltaic cells electrically coupled with the rechargeable power source and configured to supply electrical power to the rechargeable power source, wherein the recharge control circuit is configured to control a modification of the modifiable support system to cause a physical modification of at least an orientation of the modifiable support system relative to the substructural support.

2. The system of claim 1, wherein the recharge control circuit in modifying the modifiable support system causes the modifiable support system to extend away from the substructural support to expose the photovoltaic cells, and causes the modifiable support system to retract the modifiable support system toward the substructural support.

3. The system of claim 2, wherein the modifiable support system comprises a mesh structure upon which at least some of the set of photovoltaic cells are secured, wherein the mesh structure comprises apertures enabling airflow through the mesh structure at least when the modifiable support system is extended away from the substructural support.

4. The system of claim 2, wherein the modifiable support system does not provide a lifting force to the first UAV.

5. The system of claim 1, wherein the recharge control circuit in modifying the modifiable support system activates a release mechanism to release the modifiable support system from the substructural support separating the first UAV from the modifiable support system and enabling the first UAV to fly without the modifiable support system.

6. The system of claim 1, further comprising:
a sensor to detect an orientation of a source of light relative to a position of the first UAV;
wherein the recharge control circuit is communicatively coupled with the sensor and configured to receive sensor information and cause a change in physical orientation of the modifiable support system as a function of the orientation of the source of light relative to the first UAV and increasing an exposure of the set of photovoltaic cells to the source of light.

7. The system of claim 6, wherein the sensor is configured to detect the source of light as a reflected source of light;
wherein the recharge control circuit is configured cause the change in physical orientation of the modifiable support system to increase the exposure of the set of photovoltaic cells to the reflected source of light.

8. The system of claim 6, wherein the UAV control circuit is configured to modify a route of travel of the first UAV while the first UAV is in flight as a function of the orientation of the source of light relative to the first UAV to increase the exposure of the set of photovoltaic cells to the source of light.

9. The system of claim 1, wherein the modifiable support system further comprises a set of lenses each positioned relative to at least one of the photovoltaic cells of the set of photovoltaic cells and configured to increase a quantity of light directed on the respective at least one photovoltaic cell.

10. The system of claim 1, further comprising:
a radio frequency (RF) charging system cooperated with the substructural support and configured to receive a wirelessly radiated and remotely generated RF electromagnetic field and generate electrical power based on the RF electromagnetic field to charge the rechargeable electrical power source.

11. A method of monitoring a geographic area, comprising:
launching at least a first unmanned aerial vehicle (UAV) comprising a plurality of lift motors and propellers to induce at least a lifting force to cause the first UAV to fly and hover over one or more zones of the geographic area, a substructural support, a UAV control circuit configured to control the lift motors, a rechargeable electrical power source configured to supply electrical power to the UAV control circuit and the plurality of lift motors, a recharge control circuit, and a modifiable support system cooperated with the substructural support and supporting a set of photovoltaic cells electrically coupled with the rechargeable power source;
controlling a modification of the modifiable support system to cause a physical modification of at least an orientation of the modifiable support system relative to the substructural support; and
causing the set of photovoltaic cells to be exposed to a light source while the first UAV is in flight and supply electrical power to the rechargeable power source.

12. The method of claim 11, wherein the controlling the modification of the modifiable support system comprises causing the modifiable support system to extend away from the substructural support to expose the photovoltaic cells, and causing the modifiable support system to retract the modifiable support system toward the substructural support.

13. The method of claim 12, wherein the causing the modifiable support system to extend away from the substructural support comprises exposing a mesh structure of the modifiable support system and upon which at least some of the set of photovoltaic cells are secured, and enabling airflow through the mesh structure at least when the modifiable support system is extended away from the substructural support.

14. The method of claim 12, wherein the modifiable support system does not provide a lifting force to the first UAV.

15. The method of claim 11, further comprising:
activating a release mechanism and causing a release of the modifiable support system from the substructural support separating the first UAV from the modifiable support system and enabling the first UAV to fly without the modifiable support system.

16. The method of claim 11, further comprising:
detecting an orientation of a source of light relative to a position of the first UAV; and
causing a change in physical orientation of the modifiable support system as a function of the orientation of the source of light relative to the first UAV and increasing an exposure of the set of photovoltaic cells to the source of light.

17. The method of claim 16, wherein the detecting the orientation of the source of light comprises detecting a reflected source of light;
wherein the causing the change in physical orientation of the modifiable support system comprises causing the change in physical orientation to increase the exposure of the set of photovoltaic cells to the reflected source of light.

18. The method of claim 16, further comprising:
modifying a route of travel of the first UAV while the first UAV is in flight as a function of the orientation of the source of light relative to the first UAV to increase the exposure of the set of photovoltaic cells to the source of light.

19. The method of claim 11, wherein the causing the set of photovoltaic cells to be exposed to the light source comprises exposing a set of lenses each positioned relative to at least one of the photovoltaic cells of the set of photovoltaic cells, and causing an increase in a quantity of light directed on the respective at least one photovoltaic cell.

20. The method of claim 11, further comprising:
wirelessly receiving a radiated and remotely generated radio frequency (RF) electromagnetic field; and
generating electrical power based on the RF electromagnetic field to charge the rechargeable electrical power source.
